(19) United States
(12) Patent Application Publication
(10) Pub. No.: US 2017/0115753 A1
(43) Pub. Date: Apr. 27, 2017

(54) METHOD FOR DETECTING ORIENTATION OF STYLUS

(71) Applicant: WALTOP INTERNATIONAL CORPORATION, Hsinchu City (TW)

(72) Inventors: CHUNG-FUU MAO, Hsinchu City (TW); CHIA-JUI YEH, Taipei City (TW); A-Li WONG, Hsinchu City (TW); Chih Hung HUANG, Hsinchu City (TW)

(21) Appl. No.: 14/918,578

(22) Filed: Oct. 21, 2015

(51) Int. Cl. G06F 3/0354

(52) U.S. Cl. CPC G06F 3/03545

(57) ABSTRACT

A method for detecting an orientation of a stylus over a touch panel is disclosed. The method utilizes capacitance variations on a first location and a second location of the touch panel generated from a tip of a nib of the stylus and a portion of the nib corresponding to a non-shielding portion of a shielding of the stylus to determine the orientation of the stylus.

### TECHNICAL FIELD

The present invention relates to a method for detecting an orientation of a stylus, and more particularly to a method for detecting an orientation of a stylus on a touch panel and a stylus with an orientation detection function.

### DESCRIPTION OF RELATED ART

Capacitive touch input technology is widely used in the touch panel, one of advantages is allowing user to proceed input operation via user's hand or a stylus so as to have a multi touch function which can generate a variety of applications according to specific corresponding operations by various gestures. A stylus allows user to perform exquisite input operations such as writing or to execute application programs on a touch panel via user interfaces. The coordinates of a stylus can be detected via capacitive coupling between detection electrodes of a touch panel and the stylus when the stylus approaches or contacts the touch panel. In order to establish capacitive coupling with detection electrodes of a touch panel, a stylus must receive driving signals from detection electrodes and output signals to detection electrodes so that coordinates of the stylus can be detected. Beside coordinates of the stylus, tilt angle, orientation, inclination or angular information of the stylus are also essential to the applications and functions of the stylus applied on the touch panel.

### SUMMARY

An object of the present invention is to provide a method for detecting an orientation of a stylus on a touch panel. One embodiment of the present invention uses a primary peak voltage signal and non-primary peak voltage signals on a first location and a second location of the touch panel generated from a tip of a nib of the stylus and a portion of the nib corresponding to a non-shielding portion of a shielding of the stylus respectively to determine the orientation of the stylus.

Another embodiment of the present invention utilizes capacitance variations on a first location and a second location of the touch panel generated from a tip of a nib of the stylus and a portion of the nib corresponding to a non-shielding portion of a shielding of the stylus to determine the orientation of the stylus.

Another embodiment of the present invention provides a stylus with an orientation detection function. The stylus comprises a conductive nib and a shielding comprising a non-shielding portion. The shielding surrounds the conductive nib, and a tip and a portion of the conductive nib corresponding to the non-shielding portion of the stylus are configured to generate capacitance variations on locations of a touch panel.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates a stylus 10 for use with a touch panel 1 according to embodiments of the claimed invention.

FIG. 2 illustrates a schematic diagram showing the stylus 10 tilted upon the touch panel 1 according to one embodiment of the claimed invention.

FIG. 3 shows a schematic flow chart of a method for detecting an orientation of a stylus according to one embodiment of the invention.

### DETAILED DESCRIPTION

The detailed description of the present invention will be discussed in the following embodiments, which are not intended to limit the scope of the present invention, but can be adapted for other applications. While drawings are illustrated in details, it is appreciated that the scale of each component may not be expressly exactly.

In embodiments of the invention, some features related to a stylus which are not essential to the invention and are well known for any person skilled in the art to make and use the same will not be described in detail herein. For example, the following features relating to a stylus and a touch panel are well known for any person skilled in the art to make and use the same. A stylus includes a conductive tip while a touch panel has a capacitive detection array with a plurality of detection electrodes, wherein the detection electrodes comprise transmitting electrodes (Tx) and receiving electrodes (Rx). When a stylus is used upon a touch panel, the conductive tip approaches or contacts the capacitive detection array of the touch panel, and the conductive tip of the stylus will establish capacitive coupling with the detection electrodes under or adjacent the stylus. The stylus outputs a signal to the detection electrodes under or adjacent the stylus. The output signal allows the stylus to establish capacitive coupling with detection electrodes of the touch panel under or adjacent the stylus after scanning transmitting electrodes and receiving electrodes to generate a detection signal so as to calculate and determine coordinates of the stylus. Through capacitive coupling between the conductive tip and the detection electrodes, the signal from the stylus will be detected during scanning transmitting electrodes and receiving electrodes so that coordinates of the stylus can be calculated and determined. The capacitive detection array can use charge accumulation circuit, a capacitance modulation circuit, or other capacitance sensing methods known by those skilled in the art.

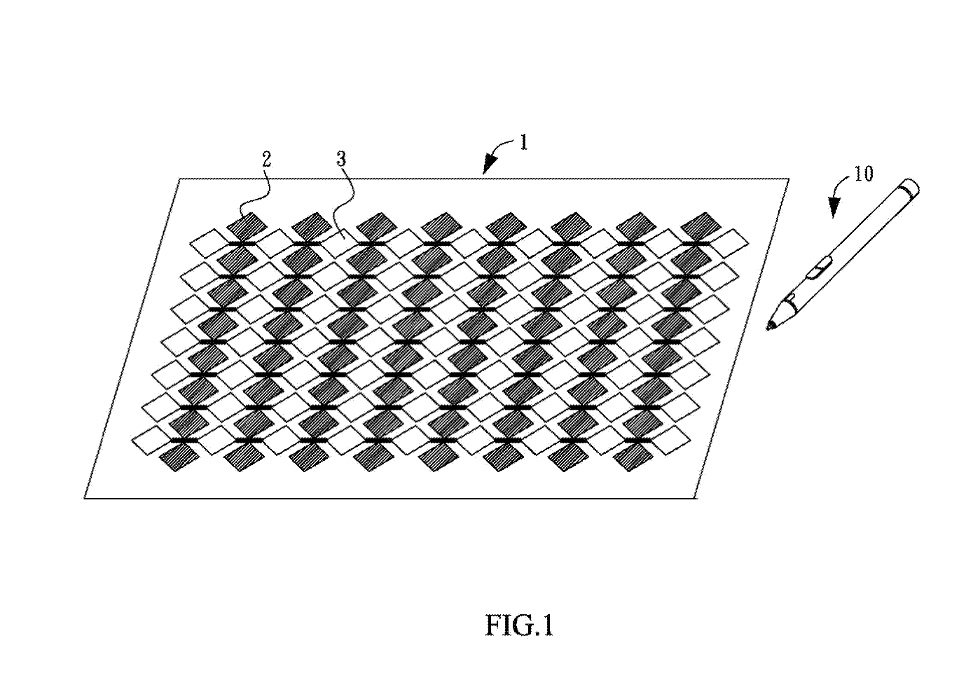

FIG. 1 illustrates a stylus 10 for use with a touch panel 1 according to embodiments of the claimed invention. As shown in FIG. 1, touch panel 1 comprises an array of electrodes 3 and 2 connected via conductive lines arranged in rows and columns respectively.

When stylus 10 touches or hovers over the touch panel 1, the stylus 10 establishes a capacitance with one or more electrodes 2 and 3, and the capacitances of the electrodes 2 and 3 are altered due to the capacitor between the stylus 10 and the electrodes 2 and 3. The sensing circuitry (not shown) of the touch panel 1 then detect signals generated from capacitance variations of the electrodes 2 and/or 3. The signals may be generated from capacitance variations of the electrodes 2 or 3 along conductive lines arranged in columns or rows. The signals may be generated from capacitance variations of the electrodes 2 and 3 along conductive lines arranged in columns and rows. Thus the sensing circuitry can obtain coordinate, orientation, inclination or angular information of the stylus via scanning the electrodes 2 and 3. The coordinate information of the stylus can be determined via detecting capacitance variations of a series of electrodes 2 or 3 along conductive lines arranged in columns or rows under the stylus 10 or capacitance variations of a single cross point of two series of electrodes 2 and 3 along conductive lines arranged in columns and rows under the stylus 10 respectively. Details of determination of orientation, inclination or angular information of the stylus will be further described in the following content.

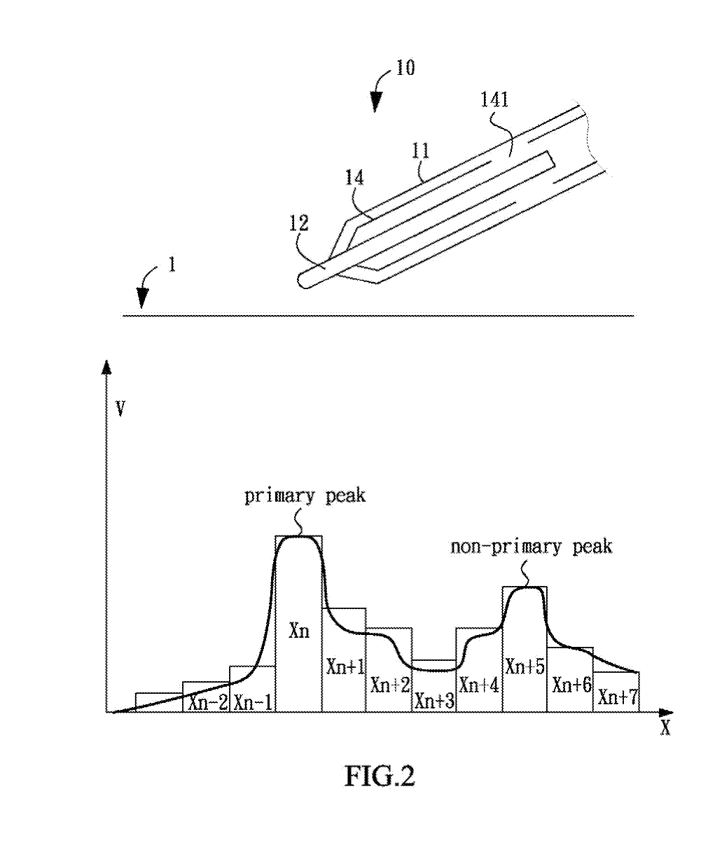

FIG. 2 illustrates a schematic diagram showing the stylus 10 tilted upon the touch panel 1 according to one embodiment of the claimed invention. In this embodiment, the stylus 10 comprises a housing 11, a nib 12 and a shielding 14. The nib 12 comprises a conductive electrode. The nib 12 outputs signals from a stylus circuitry of the stylus 10 which are usually high voltage signals. In some embodiments, the nib 12 can be replaceable. The material of the nib 12 comprises any suitable conductive material. The material of the shielding 14 comprises any suitable conductive material, and is preferably metal. The shielding 14 further comprises at least one non-shielding portion 141. The non-shielding portion 141 comprises opening, gap or non-conductive portion without shielding function. The shape or configuration or arrangement of the non-shielding portion 141 can be any suitable design. The shielding 14 is configured to be a shield for shielding a portion of output signal from the nib 12 so that only signals from the tip and the portion of the nib 12 corresponding to the non-shielding portion 141 can be detected by the touch panel 1. The housing 11 further accommodates necessary components such as a control circuit board having the stylus circuitry thereon and a pressure sensor for detecting tip pressure.

FIG. 2 also shows a schematic diagram of voltage signal distribution versus of x axis coordinates on the touch panel 1. The voltage signal distribution has one main peak value and one auxiliary peak value, wherein the transverse axis represents coordinates on the touch panel 1 and the longitudinal axis represents signal voltage values sensed by the electrodes 2 and 3. It is obvious that a similar voltage signal distribution versus coordinate on the touch panel 1 along other directions, including non x and y axial directions. Although the example described is about signal voltage distribution versus coordinate on the touch panel 1 along x axial direction, similar examples along y axial direction or non x and y axial directions could be easily anticipated.

In this embodiment, the tip of the nib 12 of the tilted stylus 10 is on Xₙ coordinate along x axial direction, a plurality of electrodes 2 and/or 3 under the nib 12 of the tilted stylus 10 will establish capacitive coupling with the tilted stylus 10. Particularly, capacitance variations of the electrodes 2 and/or 3 under the tip of the nib 12 and the non-shielding portion 141 would generate a primary peak voltage signal on Xₙ coordinate and a secondary peak voltage signal on Xₙ₊₅ coordinate after the sensing circuitry scans the electrodes 2 and 3 along conductive lines arranged in columns and rows. Auxiliary primary peak voltage signals on Xₙ₋₂, Xₙ₋₁, Xₙ₊₁ and Xₙ₊₂ coordinates aside Xₙ coordinate and auxiliary secondary peak voltage signals on Xₙ₊₄ and Xₙ₊₆ coordinates aside Xₙ₊₅ coordinate may also detected. The peak voltage signals on Xₙ₋₂, Xₙ₋₁, Xₙ Xₙ₊₁ and Xₙ₊₂ coordinates constitute a primary peak voltage signal group, while the peak voltage signals on Xₙ₊₄, Xₙ₊₅ and Xₙ₊₆ coordinates constitute a non-primary/secondary peak voltage signal group. Since voltage signals will mainly be generated on coordinates under the nib 12 of the tilted stylus 10, the orientation, inclination or angular information of the tilted stylus 10 can be obtained through the voltage signals generated from capacitance variations of the electrodes 2 and/or 3 under the tip of the nib 12 and the non-shielding portion 141.

In one embodiment, the tilt degree of the stylus 10 can be calculated by the following equations:

Tilt degree={(V_{Xn+4}+V_{Xn+5}+V_{Xn+6})/(V_{Xn-1}+V_{Xn}+V_{Xn+1})}*90 degree

or

Tilt degree={(V_{Xn+4}+V_{Xn+5}+V_{Xn+6})*K/(V_{Xn-2}+V_{Xn-1}+V_{Xn}+V_{Xn+1}+V_{Xn+2})}*90 degree

(K is an adjusting parameter for tilt ratio.)
or

Tilt ratio={(secondary peak voltage signal)/(primary peak voltage signal)}

or

Tilt ratio={(sum of secondary peak group)/(sum of primary peak group)}

However, the orientation, inclination or angular information of the tilted stylus 10 can be obtained via other ways. It is easily expected that the ratio between the primary peak voltage signal and the secondary peak voltage signal generated from capacitance variations of the electrodes 2 and/or 3 under the tip of the nib 12 and the non-shielding portion 141 respectively is a function of the inclination amount of the stylus 10. For example, the larger the stylus 10 tilts, the more the ratio approaches 1. Conversely, the lesser the stylus 10 tilts, the more the ratio approaches zero.

Moreover, the distance between the primary peak voltage signal and the secondary peak voltage signal generated from capacitance variations of the electrodes 2 and/or 3 under the tip of the nib 12 and the non-shielding portion 141 respectively is also a function of the inclination amount of the stylus 10. For example, the larger the stylus 10 tilts, the larger the distance is. Conversely, the lesser the stylus 10 tilts, the smaller the distance is. Moreover, the distance between the locations of the electrodes 2 and/or 3 under the tip of the nib 12 and the non-shielding portion 141 is also a function of the inclination amount of the stylus 10.

The rotation of the stylus 10 can also be determined by the primary peak voltage signal and the secondary peak voltage signal generated from capacitance variations of the electrodes 2 and/or 3 under the tip of the nib 12 and the non-shielding portion 141 respectively. For example, various designs of shape or configuration or arrangement of the non-shielding portion 141 of the shielding 14 can induce various and different secondary or non-primary peak voltage signals on the electrodes 2 and/or 3 under or close to the non-shielding portion 141. For example, the non-shielding portion 141 comprises three openings or non-conductive parts without shielding function arranged in a circular manner around the shielding 14 which can induce non-primary peak voltage signals on the electrodes 2 and/or 3 under or close to the non-shielding portion 141. Through determining the relative location changes of non-primary peak voltage signals, the rotation of the stylus 10 can be determined. For example, as the stylus 10 rotates, the non-primary peak voltage signals correspondingly rotate as their magnitudes change. Accordingly, a determination can be made regarding how much the stylus 10 rotated between the orientations.

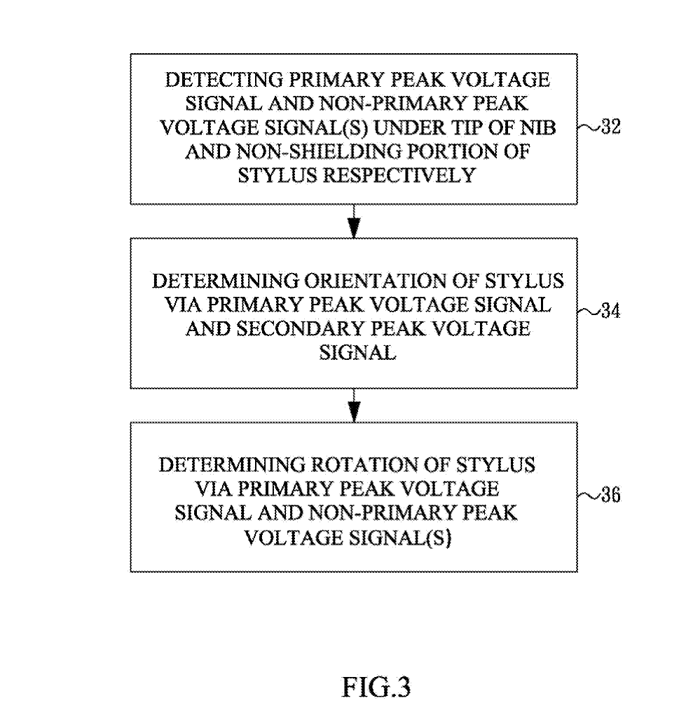

FIG. 3 shows a schematic flow chart of a method for detecting an orientation of a stylus according to one embodiment of the invention. In step 32, a primary peak voltage signal and non-primary peak voltage signals under a tip of a nib and a non-shielding portion of a shielding in a stylus touching or hovering over a touch panel are detected respectively. The non-primary peak voltage signals are preferably generated from capacitive coupling between the portions of the nib corresponding to the non-shielding portion of the shielding and the electrodes of the touch panel under the portions of the nib. Then in step 34, the orientation of the stylus is determined via the primary peak voltage signal and a secondary peak voltage signal. The secondary peak voltage signal should have the largest value among the non-primary peak voltage signals. The orientation, inclination or angular information of the stylus can be determined via the ratio or the distance between the primary peak voltage signal and a secondary peak voltage signal. Finally, the rotation of stylus is determined via the primary peak voltage signal and the non-primary peak voltage signals in step 36. The method for detecting an orientation of a stylus can be performed by firmware stored in memory and executed by microprocessor unit of stylus circuitry.

Although specific embodiments have been illustrated and described, it will be appreciated by those skilled in the art that various modifications may be made without departing from the scope of the present invention, which is intended to be limited solely by the appended claims.

What is claimed is:

1. A method for detecting an orientation of a stylus, comprising:
providing a stylus over a touch panel;
detecting a primary peak voltage signal group and a non-primary peak voltage signal group, the primary peak voltage signal group comprising a primary peak voltage signal on a first location and the non-primary peak voltage signal group comprising a secondary peak voltage signal on a second location of the touch panel generated from a tip of a nib of the stylus and a portion of the nib corresponding to a non-shielding portion of a shielding of the stylus respectively; and
determining an orientation of the stylus via the primary peak voltage signal group and the non-primary peak voltage signal group.

2. The method according to claim 1 further comprising a step of determining a rotation of the stylus via the primary peak voltage signal group and the non-primary peak voltage signal group.

3. The method according to claim 1, wherein the non-shielding portion comprises at least one opening, gap or non-conductive portion without shielding function.

4. The method according to claim 3, wherein the non-shielding portion comprises openings arranged in a circular manner around the shielding.

5. The method according to claim 4, wherein the rotation of the stylus is determined via relative location changes of non-primary peak voltage signals of the non-primary peak voltage signal group on the touch panel.

6. The method according to claim 1, wherein the orientation of the stylus is determined via a ratio between a sum of the non-primary peak voltage signal group and a sum of the primary peak voltage signal group.

7. The method according to claim 1, wherein the orientation of the stylus is determined via a ratio between the primary peak voltage signal and the secondary peak voltage signal.

8. The method according to claim 1, wherein the orientation of the stylus is determined via a distance between the first location and the second location on the touch panel.

9. A method for detecting an orientation of a stylus, comprising:
providing a stylus over a touch panel;
detecting capacitance variations on a first location and a second location of the touch panel generated from a tip of a nib of the stylus and a portion of the nib corresponding to a non-shielding portion of a shielding of the stylus respectively; and
determining an orientation of the stylus via the capacitance variations on the first location and the second location.

10. The method according to claim 9, wherein the non-shielding portion comprises at least one opening, gap or non-conductive portion without shielding function.

11. The method according to claim 10, wherein the non-shielding portion comprises non-conductive parts arranged in a circular manner around the shielding.

12. The method according to claim 11 further comprising a step of determining a rotation of the stylus via capacitance variations on locations of the touch panel generated from portions of the nib corresponding to the non-conductive parts of the shielding of the stylus.

13. The method according to claim 12, wherein the rotation of the stylus is determined via relative location changes of the capacitance variations on the locations of the touch panel generated from the portions of the nib corresponding to the non-conductive parts of the shielding of the stylus.

14. The method according to claim 9, wherein the orientation of the stylus is determined via a ratio between the capacitance variations on the second location and the capacitance variations on the first location.

15. The method according to claim 9, wherein the orientation of the stylus is determined via a distance between the first location and the second location on the touch panel.

16. A stylus with an orientation detection function, comprising:
a conductive nib; and
a shielding comprising a non-shielding portion, wherein the shielding surrounds the conductive nib, and a tip and a portion of the conductive nib corresponding to the non-shielding portion of the stylus are configured to generate capacitance variations on locations of a touch panel.

17. The stylus according to claim 16, wherein the conductive nib is replaceable.

18. The stylus according to claim 16, wherein the non-shielding portion comprises at least one opening, gap or non-conductive portion without shielding function.

19. The stylus according to claim 16, wherein the non-shielding portion comprises non-conductive parts arranged in a circular manner around the shielding.

20. The stylus according to claim 16, wherein the non-shielding portion comprises openings arranged in a circular manner around the shielding.
